(19) United States
(12) Patent Application Publication
(10) Pub. No.: US 2017/0004794 A1
(43) Pub. Date: Jan. 5, 2017

(54) A DRIVING CIRCUIT, A DRIVING METHOD THEREOF, AND A LIQUID CRYSTAL DISPLAY

(71) Applicant: Shenzhen China Star Optoelectronics Technology Co., Ltd., Shenzhen, Guangdong (CN)

(72) Inventor: Qiuping HUANG, Shenzhen, Guangdong (CN)

(73) Assignee: Shenzhen China Star Optoelectronics Technology Co., Ltd., Shenzhen, Guangdong (CN)

(21) Appl. No.: 14/765,832

(22) PCT Filed: Jun. 30, 2015
(86) PCT No.: PCT/CN2015/082824

§ 371 Date: Aug. 4, 2015

(51) Int. Cl. G09G 3/36

(52) U.S. Cl. CPC G09G 3/3677; G09G 3/3688; G09G 2310/0251; G09G 2300/0426; G09G 2310/06

(57) ABSTRACT

The present invention is to provide a driving circuit, and a method and a liquid crystal display (LCD) thereof. The driving circuit includes a plurality of scan lines and a plurality of data lines which are perpendicular to each other. A plurality of pixel regions is defined by the plurality of scan lines and the plurality of data lines. Each pixel region includes a pixel, at least two thin film transistors (TFTs). A gate electrode and a source electrode of each TFT are connected with a scan line and a data line respectively, and a drain electrode thereof is connected with the pixel, wherein the pixel is charged when the two TFTs are open. Therefore, the charging time of the pixel is increased and g quality of the picture displayed by the LCD is improved.

### BACKGROUND

Technical Field

The present invention relates to liquid crystal display field, and more particularly, to a driving circuit, a driving method thereof, and a liquid crystal display.

Description of Related Art

A liquid crystal display (LCD) gradually becomes the mainstream of the market because of its characteristic of low radiation, low power consumption, and small size. LCD has been widely applied in cell phone, laptop, and panel TV.

FIG. 1 shows a conventional pixel structure and driving method of LCD. A sub-pixel P1 is connected with a sub-pixel electrode through a scan line G1 driving a data line D1 corresponding to the scan line G1. When scanning signal scans in order, TFT of each sub-pixel will open in order and data signal will input to the sub-pixel electrode through data line so pictures are displayed.

The LCD evolves into big size, high revolution, high definition, etc, so the operation frequency of the LCD and the pixel resolution are promoted continuously. The coming problem is that the charge time of capacitance become less rapidly. When the revolution of LCD is promoted to 4K*2K, even above 8K*4K, for example, the conventional scanning frequency, 60 Hz, will be increased into 120 Hz, 240 Hz, or even above 480 Hz. The time of inputting data signal through the data line becomes short. It is ¼, ⅛, or even 1/16 of the present inputting time. The problem of insufficient power of the pixel exists and the quality of the picture is influenced.

### SUMMARY

The present invention is to provide a driving circuit, and a method and a liquid crystal display (LCD) thereof, for increasing the charging time of the pixel and improving quality of the picture displayed by the LCD.

For solving the aforementioned problem, the present invention provides a driving circuit applied in LCD. The driving circuit includes a plurality of scan lines and a plurality of data lines which are perpendicular to each other. A plurality of pixel regions is defined by the plurality of scan lines and the plurality of data lines. The pixel region defined by the m line and the n row includes a pixel (Pm), a first thin film transistor (TFT) (Tm1), a second TFT (Tm2), a first scan line (Gm1), a second scan line (Gm2), a first data line (Dm1), and a second data line (Dm2), wherein the m and n are natural numbers. Drain electrodes of the first TFT Tm1 and the second TFT Tm2 are both connected with the pixel Pm. A gate electrode of the first TFT Tm1 is connected with the first scan line Gm1 and a source electrode thereof is connected with the first data line Dm1. A gate electrode of the second TFT Tm2 is connected with the second scan line Gm2 and a source electrode thereof is connected with the second data line Dm2. A driving signal of the first scan line G11 drives the first TFT T11 to be opened and the pixel P1 is charged by the power (not shown here) through the first data line D11. A driving signal of the second scan line G12 drives the second TFT T12 to be opened and the pixel P1 is charged by the power (not shown here) through the second data line D12.

The pixel region defined by the m line and the n row includes a pixel (Pm), a first thin film transistor (TFT) (Tm1), a second TFT (Tm2), a scan line (Gm), a first data line (Dm1), and a second data line (Dm2), wherein the m and n are natural numbers. Drain electrodes of the first TFT Tm1 and the second TFT Tm2 are both connected with the pixel Pm. A gate electrode of the first TFT Tm1 is connected with the scan line Gm and a source electrode thereof is connected with the first data line Dm1. A gate electrode of the second TFT Tm2 is connected with the second scan line Gm+1 on the m+1 line and a source electrode thereof is connected with the second data line Dm2.

The first data line Dm1 and the second data line Dm2 can be the same data line.

For solving the aforementioned problem, the present invention provides an LCD includes a display panel and a backlight unit (BLU). The display panel includes a driving circuit including plurality of scan lines and a plurality of data lines which are perpendicular to each other. A plurality of pixel regions is defined by the plurality of scan lines and the plurality of data lines. Each pixel region includes a pixel and at least two TFTs. A gate electrode and a source electrode of each TFT are connected with a scan line and a data line respectively, and a drain electrode thereof is connected with the pixel, wherein the pixel is charged when the two TFTs are open.

The pixel region defined by the m line and the n row includes a pixel (Pm), a first TFT (Tm1), a second TFT (Tm2), a first scan line (Gm1), a second scan line (Gm2), a first data line (Dm1), and a second data line (Dm2), wherein m and n are natural numbers. Drain electrodes of the first TFT Tm1 and the second TFT Tm2 are both connected with the pixel Pm. A gate electrode of the first TFT Tm1 is connected with the first scan line Gm1 and a source electrode thereof is connected with the first data line Dm1. A gate electrode of the second TFT Tm2 is connected with the second scan line Gm2 and a source electrode thereof is connected with the second data line Dm2.

The pixel region defined by the m line and the n row includes a pixel (Pm), a first TFT (Tm1), a second TFT (Tm2), a scan line (Gm), a first data line (Dm1), and a second data line (Dm2), wherein the m and n are natural numbers. Drain electrodes of the first TFT Tm1 and the second TFT Tm2 are both connected with the pixel Pm. A gate electrode of the first TFT Tm1 is connected with the scan line Gm and a source electrode thereof is connected with the first data line Dm1. A gate electrode of the second TFT Tm2 is connected with the scan line Gm+1 on the m+1 line and a source electrode thereof is connected with the second data line Dm2.

The first data line Dm1 and the second data line Dm2 can be the same data line.

For solving the aforementioned problem, the present invention provides a driving method applied in the driving circuit including a plurality of pixel regions. Each pixel region includes a pixel and at least two TFTs. A gate electrode and a source electrode of each TFT are connected with a scan line and a data line respectively, and a drain electrode thereof is connected with the pixel. The driving method include that the plurality of TFTs in each pixel region are opened in order to keep charging the pixel.

The pixel region defined by the m line and the n row includes a pixel (Pm), a first TFT (Tm1), a second TFT (Tm2), a first scan line (Gm1), a second scan line (Gm2), a first data line (Dm1), and a second data line (Dm2). The driving method includes S1: During 0-T, a first level signal is inputted through the first scan line Gm1 to open the first TFT Tm1 and the pixel P1 is charged through the first data line Dm1. S2: During T-2T, a second level signal is inputted through the first scan line Gm1 to close the first TFT Tm1 and the first level signal is inputted through the second scan line Gm2 to open the second TFT Tm2. The pixel Pm is charged through the second data line Dm2.

The step S2 includes: S21. During T-2T, a first level signal is inputted through the first scan line Gm1 to open the first TFT Tm1 and the first level signal is inputted through the second scan line Gm2 to open the second TFT Tm2. The pixel Pm is charged through the first data line Dm1 and the second data line Dm2; S22. During 2T-3T, a second level signal is inputted through the first scan line Gm1 to close the first TFT Tm1 and the first level signal is inputted through the second scan line Gm2 to open the second TFT Tm2. The pixel Pm is charged through the second data line Dm2.

The pixel region defined by the m line and the n row includes a pixel (Pm), a first TFT (Tm1), a second TFT (Tm2), a scan line (Gm), a first data line (Dm1), and a second data line (Dm2). The driving method includes M1: During 0-T, a first level signal is inputted through the first scan line Gm to open the first TFT Tm1 and the pixel Pm is charged through the first data line Dm1; M2: During T-2T, a second level signal is inputted through the first scan line Gm to close the first TFT Tm1 and the first level signal is inputted through the scan line Gm+1 on the next line to open the second TFT Tm2. The pixel Pm is charged through the second data line Dm2. Scanning other lines of the above driving circuit is performed by the above method.

The step M2 includes: M21: During T-2T, a first level signal is inputted through the scan line Gm to open the first TFT Tm1 and the first level signal is inputted through the second scan line Gm+1 to open the second TFT Tm2. The pixel Pm is charged through the first data line Dm1 and the second data line Dm2. At the same time, scanning next line is performed. M22: during 2T-3T, a second level signal is inputted through the first scan line Gm to close the first TFT Tm1 and the first level signal is inputted through the scan line Gm+1 on the next line to open the second TFT Tm2. The pixel Pm is charged through the second data line Dm2.

The benefit of the present invention is that to distinguish from the conventional technique, the driving circuit includes a plurality of scan lines and a plurality of data lines which are perpendicular to each other. A plurality of pixel regions is defined by the plurality of scan lines and the plurality of data lines. Each pixel region includes a pixel and at least two TFTs. A gate electrode and a source electrode of each TFT are connected with a scan line and a data line respectively, and a drain electrode thereof is connected with the pixel, wherein the pixel is charged when the two TFTs are open. The charging time can be increased and quality of the picture displayed by the LCD can be improved.

### BRIEF DESCRIPTION OF THE DRAWINGS

The accompanying drawings are included to provide easy understanding of the application, are incorporated herein and constitute a part of this specification. The drawings illustrate embodiments of the application and, together with the description, serve to illustrate the principles of the application.

FIG. 1 is a pixel structure and driving method of the conventional LCD.

FIG. 2 is a schematic diagram of a structure of a driving circuit in accordance with a first embodiment of the present invention.

FIG. 3 is a schematic diagram of another structure of a driving circuit in accordance with a first embodiment of the present invention.

FIG. 4 is a schematic diagram of a structure of a driving circuit in accordance with a second embodiment of the present invention.

FIG. 5 is a flow chart of a driving method in accordance with the first embodiment of the present invention.

FIG. 6 is a first waveform diagram of a scan line of the driving method in accordance with the first embodiment of the present invention.

FIG. 7 is a second waveform diagram of the scan line of the driving method in accordance with the first embodiment of the present invention.

FIG. 8 is a flow chart of a driving method in accordance with the second embodiment of the present invention.

FIG. 9 is a first waveform diagram of a scan line of the driving method in accordance with the second embodiment of the present invention.

FIG. 10 is a second waveform diagram of the scan line of the driving method in accordance with the second embodiment of the present invention.

FIG. 11 is a schematic diagram of a structure of an LCD in accordance with an embodiment of the present invention.

### DESCRIPTION OF THE PREFERRED EMBODIMENTS

To better and concisely explain the disclosure, the same name or the same reference number given or appeared in different paragraphs or figures along the specification should has the same or equivalent meanings while it is once defined anywhere of the disclosure.

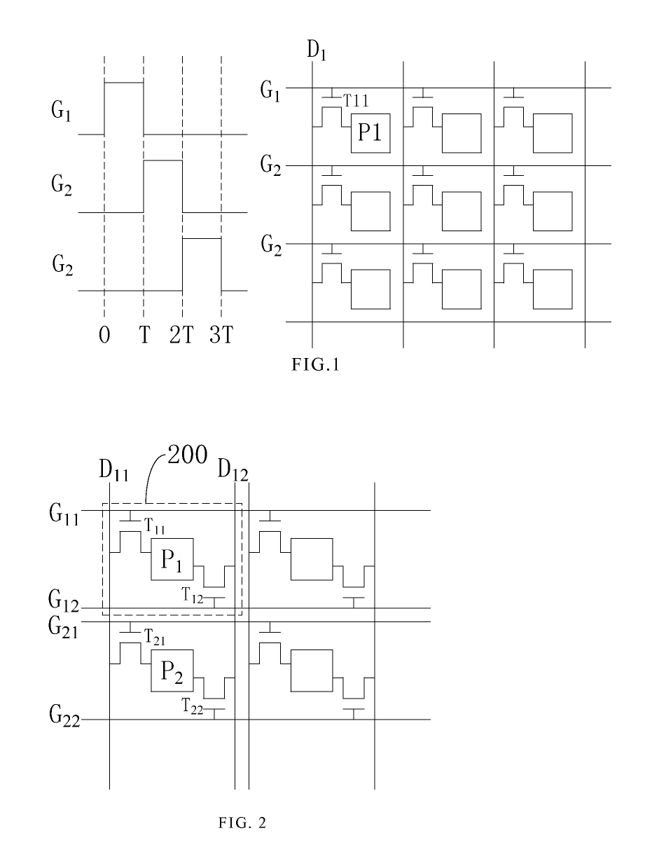

FIG. 2 is a schematic diagram of a structure of a driving circuit in accordance with a first embodiment of the present invention. The driving circuit includes a plurality of scan lines and a plurality of data lines which are perpendicular to each other. A plurality of pixel regions is defined by the plurality of scan lines and the plurality of data lines. Each pixel region includes a pixel and at least two thin film transistors (TFTs). A gate electrode and a source electrode of each TFT are connected with a scan line and a data line respectively, and a drain electrode thereof is connected with the pixel, wherein the pixel is charged when the two TFTs are open.

FIG. 2 shows that each pixel region includes a pixel, two TFTs, two scan lines, and two data lines. The figure is for example and does not limit the scope of this embodiment. The numbers of the TFT, the scan line, and the data line can be added.

The following is exemplified by a pixel region 200 defined by the first line and the first row is for example

The pixel region 200 includes a pixel P1, a first TFT T11, a second TFT T12, a first scan line G11, a second scan line G12, a first data line D11, and a second data line D12.

Drain electrodes of the first TFT T11 and the second TFT T12 are both connected with the pixel P1. A gate electrode of the first TFT T11 is connected with the first scan line G11 and a source electrode thereof is connected with the first data line D11. A gate electrode of the second TFT T12 is connected with the second scan line G12 and a source electrode thereof is connected with the second data line D12.

In this embodiment, a driving signal of the first scan line G11 drives the first TFT T11 to be opened and the pixel P1 is charged by the power (not shown here) through the first data line D11. A driving signal of the second scan line G12 drives the second TFT T12 to be opened and the pixel P1 is charged by the power (not shown here) through the second data line D12. The above two charging processes can perform simultaneously or respectively. The above two charging processes can perform in turn as well.

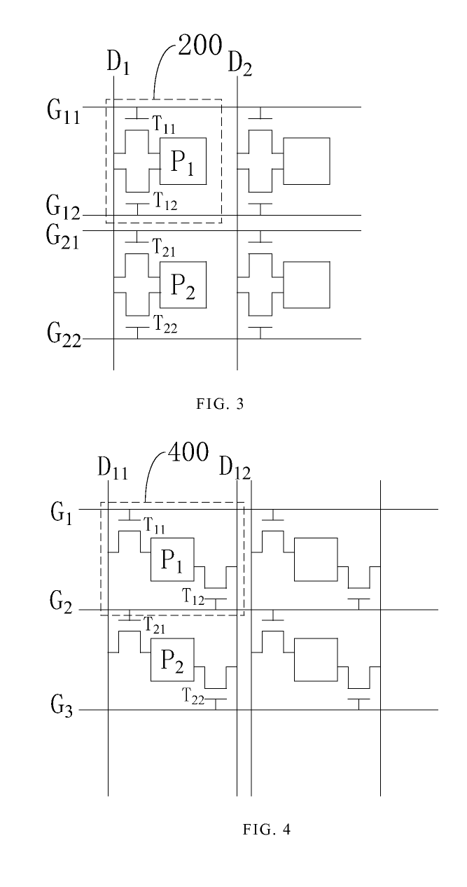

Referring to FIG. 3, the first data line D11 and the second data line D12 can be the same data line, D1 in FIG. 3.

A method of this embodiment provides a driving circuit including plurality of scan lines and a plurality of data lines which are perpendicular to each other. A plurality of pixel regions is defined by the plurality of scan lines and the plurality of data lines. Each pixel region includes a pixel and at least two TFTs. A gate electrode and a source electrode of each TFT are connected with a scan line and a data line respectively, and a drain electrode thereof is connected with the pixel, wherein the pixel is charged when the two TFTs are open and the charging time can be increased. Quality of the picture displayed by the LCD can be improved.

FIG. 4 is a schematic diagram of a structure of a driving circuit in accordance with a second embodiment of the present invention. The driving circuit includes a plurality of scan lines and a plurality of data lines which are perpendicular to each other. A plurality of pixel regions is defined by the plurality of scan lines and the plurality of data lines. Each pixel region includes a pixel and at least two thin film transistors (TFTs). A gate electrode and a source electrode of each TFT are connected with a scan line and a data line respectively, and a drain electrode thereof is connected with the pixel, wherein the pixel is charged when the two TFTs are open.

The following is exemplified by a pixel region 400 defined by the first line and the first row is for example

The pixel region 400 includes a pixel P1, a first TFT T11, a second TFT T12, a first scan line G1, a first data line D11, and a second data line D12.

Drain electrodes of the first TFT T11 and the second TFT T12 are both connected with the pixel P1. A gate electrode of the first TFT T11 is connected with the first scan line G11 and a source electrode thereof is connected with the first data line D11. A gate electrode of the second TFT T12 is connected with the second scan line G2 on the second line and a source electrode thereof is connected with the second data line D12.

In this embodiment, a driving signal of the first scan line G1 drives the first TFT T11 to be opened and the pixel P1 is charged by the power (not shown here) through the first data line D11. A driving signal of the second scan line G2 drives the second TFT T12 to be opened and the pixel P1 is charged by the power (not shown here) through the second data line D12. The above two charging processes can perform simultaneously or respectively. The above two charging processes can perform in turn as well.

In addition, the first data line D11 and the second data line D12 can be the same data line.

FIG. 5 is a flow chart of a driving method in accordance with the first embodiment of the present invention. This method is applied in the driving circuit shown in FIG. 2 and includes:

S1: During 0-T, a first level signal is inputted through the first scan line G11 to open the first TFT T11 and the pixel P1 is charged through the first data line D11.

S2: During T-2T, a second level signal is inputted through the first scan line G11 to close the first TFT T11 and the first level signal is inputted through the second scan line G12 to open the second TFT T12. The pixel P1 is charged through the second data line D12.

Scanning other lines of the above driving circuit is performed by the above method.

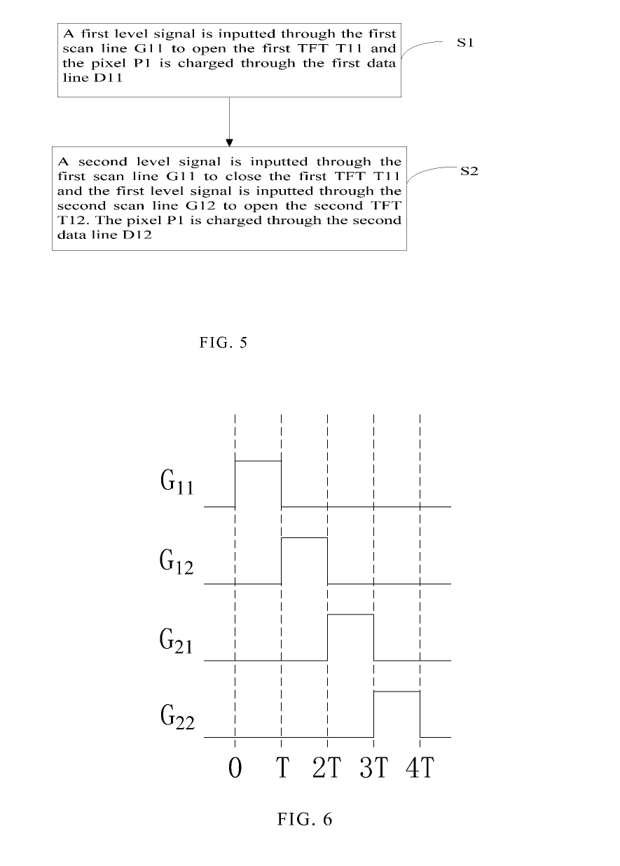

As FIG. 6 shows, each scan signal keeps T time so the charging time of each pixel is 2T. The step S2 includes:

S21: During T-2T, a first level signal is inputted through the first scan line G11 to open the first TFT T11 and the first level signal is inputted through the second scan line G12 to open the second TFT T12. The pixel P1 is charged through the first data line D11 and the second data line D12.

S22: During 2T-3T, a second level signal is inputted through the first scan line G11 to close the first TFT T11 and the first level signal is inputted through the second scan line G12 to open the second TFT T12. The pixel P1 is charged through the second data line D12.

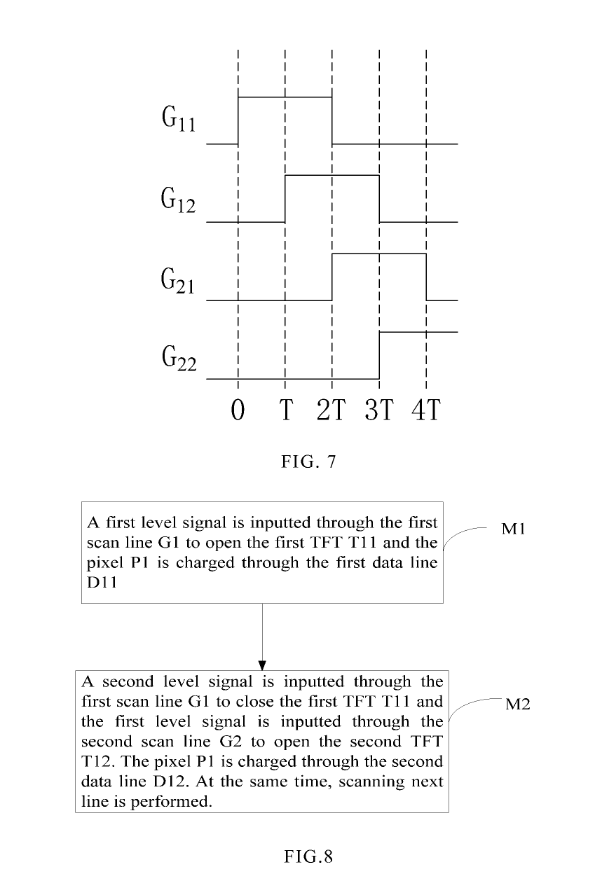

As FIG. 7 shows, each scan signal keeps 2T time so the charging time of each pixel is 3T.

FIG. 8 is a flow chart of a driving method in accordance with the second embodiment of the present invention. This method is applied in the driving circuit shown in FIG. 4 and includes:

M1: During 0-T, a first level signal is inputted through the first scan line G1 to open the first TFT T11 and the pixel P1 is charged through the first data line D11.

M2: During T-2T, a second level signal is inputted through the first scan line G1 to close the first TFT T11 and the first level signal is inputted through the second scan line G2 to open the second TFT T12. The pixel P1 is charged through the second data line D12.

Scanning other lines of the above driving circuit is performed by the above method.

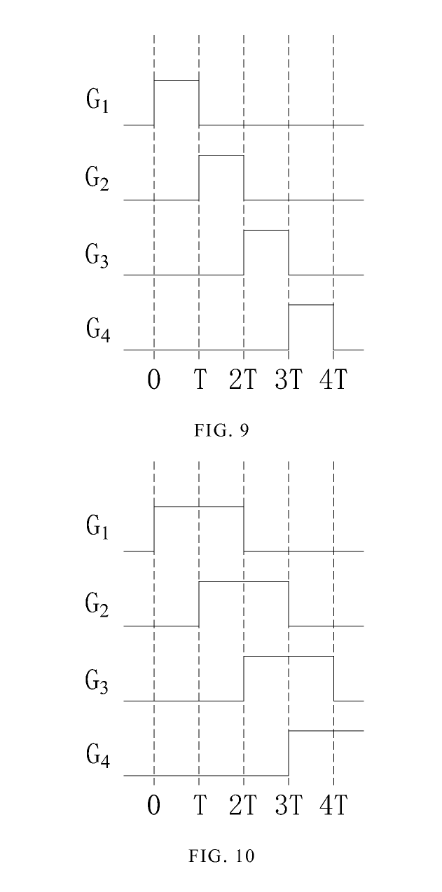

As FIG. 9 shows, each scan signal keeps T time so the charging time of each pixel is 2T. The step M2 includes:

M21: During T-2T, a first level signal is inputted through the first scan line G1 to open the first TFT T11 and the first level signal is inputted through the second scan line G2 to open the second TFT T12. The pixel P1 is charged through the first data line D11 and the second data line D12. At the same time, scanning next line is performed.

M22: During 2T-3T, a second level signal is inputted through the first scan line G1 to close the first TFT T11 and the first level signal is inputted through the second scan line G2 to open the second TFT T12. The pixel P1 is charged through the second data line D12. At the same time, scanning next line is performed.

As FIG. 10 shows, each scan signal keeps 2T time so the charging time of each pixel is 3T.

To distinguish from the conventional technique, the pixel is charged through two data lines in different times in accordance with the method of this embodiment. The charging time of each pixel is increased to 2T from T, even 3T. With increasing the charging time of the pixel, quality of the picture displayed by the LCD can be improved.

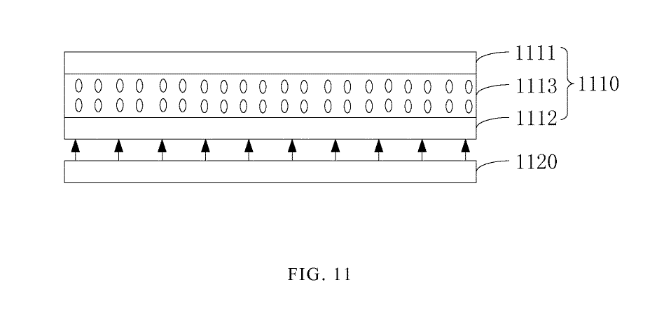

FIG. 11 is a schematic diagram of a structure of an LCD in accordance with an embodiment of the present invention. The LCD includes a display panel 1110 and a backlight unit (BLU) 1120.

The display panel 1110 includes a color filter substrate 1111, an array substrate 1112, and a liquid crystal (LC) layer 1113 therebetween. The driving circuit (not shown here) is formed on the array substrate 1112. The driving circuit is disclosed in the aforementioned embodiments in this invention.

It will be apparent to those having ordinary skill in the art that various modifications and variations can be made to the devices in accordance with the present disclosure without departing from the scope or spirit of the disclosure. In view of the foregoing, it is intended that the present disclosure covers modifications and variations of this disclosure provided they fall within the scope of the following claims and their equivalents.

What is claimed is:

1. A driving circuit applied in a liquid crystal display (LCD), comprising:
a plurality of scan lines and a plurality of data lines which are perpendicular to each other, and s plurality of pixel regions is defined by the plurality of scan lines and the plurality of data lines;
the pixel region defined by the m line and the n row comprising a pixel (Pm), a first thin film transistor (TFT) (Tm1), a second TFT (Tm2), a first scan line (Gm1), a second scan line (Gm2), a first data line (Dm1), and a second data line (Dm2), wherein the m and n are natural numbers;
drain electrodes of the first TFT Tm1 and the second TFT Tm2 connected with the pixel Pm;
a gate electrode of the first TFT Tm1 connected with the first scan line Gm1 and a source electrode thereof connected with the first data line Dm1;
a gate electrode of the second TFT Tm2 connected with the second scan line Gm2 and a source electrode thereof connected with the second data line Dm2;
a driving signal of the first scan line G11 driving the first TFT T11 to be opened and the pixel P1 is charged by the power through the first data line D11;
a driving signal of the second scan line G12 drives the second TFT T12 to be opened and the pixel P1 is charged by the power through the second data line D12.

2. The driving circuit of claim 1, wherein the pixel region defined by the m line and the n row comprises a pixel (Pm), a first thin film transistor (TFT) (Tm1), a second TFT (Tm2), a scan line (Gm), a first data line (Dm1), and a second data line (Dm2), drain electrodes of the first TFT Tm1 and the second TFT Tm2 are both connected with the pixel Pm, a gate electrode of the first TFT Tm1 is connected with the scan line Gm and a source electrode thereof is connected with the first data line Dm1, a gate electrode of the second TFT Tm2 is connected with the second scan line Gm+1 on the m+1 line and a source electrode thereof is connected with the second data line Dm2.

3. The driving circuit of claim 2, wherein the first data line Dm1 and the second data line Dm2 is the same data line.

4. An LCD, comprising:
a display panel; and
a backlight unit (BLU),
wherein the display panel comprises a driving circuit comprising a plurality of scan lines and a plurality of data lines which are perpendicular to each other, a plurality of pixel regions is defined by the plurality of scan lines and the plurality of data lines, each pixel region comprises a pixel and at least two TFTs, a gate electrode and a source electrode of each TFT are connected with a scan line and a data line respectively, and a drain electrode thereof is connected with the pixel, wherein the pixel is charged when the two TFTs are open.

5. The LCD of claim 3, wherein the pixel region defined by the m line and the n row comprising a pixel (Pm), a first thin film transistor (TFT) (Tm1), a second TFT (Tm2), a first scan line (Gm1), a second scan line (Gm2), a first data line (Dm1), and a second data line (Dm2), wherein the m and n are natural numbers;
drain electrodes of the first TFT Tm1 and the second TFT Tm2 connected with the pixel Pm;
a gate electrode of the first TFT Tm1 connected with the first scan line Gm1 and a source electrode thereof connected with the first data line Dm1;
a gate electrode of the second TFT Tm2 connected with the second scan line Gm2 and a source electrode thereof connected with the second data line Dm2

6. The LCD of claim 4, wherein the pixel region defined by the m line and the n row comprises a pixel (Pm), a first thin film transistor (TFT) (Tm1), a second TFT (Tm2), a scan line (Gm), a first data line (Dm1), and a second data line (Dm2), drain electrodes of the first TFT Tm1 and the second TFT Tm2 are both connected with the pixel Pm, a gate electrode of the first TFT Tm1 is connected with the scan line Gm and a source electrode thereof is connected with the first data line Dm1, a gate electrode of the second TFT Tm2 is connected with the second scan line Gm+1 on the m+1 line and a source electrode thereof is connected with the second data line Dm2.

7. The LCD of claim 6, wherein the first data line Dm1 and the second data line Dm2 is the same data line.

8. A driving method applied in a driving circuit having a plurality of pixel regions, each pixel region having a pixel and at least two TFTs, a gate electrode and a source electrode of each TFT connected with a scan line and a data line respectively, and a drain electrode thereof connected with the pixel, the driving method comprising:
the plurality of TFTs in each pixel region being opened in order to keep charging the pixel.

9. The driving method of claim 8, wherein the pixel region defined by the m line and the n row comprises a pixel (Pm), a first TFT (Tm1), a second TFT (Tm2), a first scan line (Gm1), a second scan line (Gm2), a first data line (Dm1), and a second data line (Dm2), and the driving method comprises:
S1: during 0-T, a first level signal being inputted through the first scan line Gm1 to open the first TFT Tm1 and the pixel P1 being charged through the first data line Dm1;
S2: during T-2T, a second level signal being inputted through the first scan line Gm1 to close the first TFT Tm1 and the first level signal being inputted through the second scan line Gm2 to open the second TFT Tm2, and the pixel Pm being charged through the second data line Dm2; and
scanning other lines of the above driving circuit by the above method

10. The driving method of claim 9, wherein the step S2 comprises:
S21: during T-2T, a first level signal being inputted through the first scan line Gm1 to open the first TFT Tm1 and the first level signal being inputted through the second scan line Gm2 to open the second TFT Tm2, and the pixel Pm being charged through the first data line Dm1 and the second data line Dm2; and
S22: during 2T-3T, a second level signal being inputted through the first scan line Gm1 to close the first TFT Tm1 and the first level signal being inputted through the second scan line Gm2 to open the second TFT Tm2, and the pixel Pm being charged through the second data line Dm2.

11. The driving method of claim 8, wherein the pixel region defined by the m line and the n row comprises a pixel (Pm), a first TFT (Tm1), a second TFT (Tm2), a scan line (Gm), a first data line (Dm1), and a second data line (Dm2), and the driving method comprises:
M1: during 0-T, a first level signal being inputted through the first scan line Gm to open the first TFT Tm1 and the pixel Pm being charged through the first data line Dm1;
M2: during T-2T, a second level signal being inputted through the first scan line Gm to close the first TFT Tm1 and the first level signal being inputted through the scan line Gm+1 on the next line to open the second TFT Tm2, and the pixel Pm being charged through the second data line Dm2; and
scanning other lines of the above driving circuit by the above method.

12. The driving method of claim 11, wherein the step M2 comprises:
M21: during T-2T, a first level signal being inputted through the scan line Gm to open the first TFT Tm1 and the first level signal being inputted through the second scan line Gm+1 to open the second TFT Tm2, the pixel Pm being charged through the first data line Dm1 and the second data line Dm2, and scanning next line at the same time; and
M22: during 2T-3T, a second level signal being inputted through the first scan line Gm to close the first TFT Tm1 and the first level signal being inputted through the scan line Gm+1 on the next line to open the second TFT Tm2, and the pixel Pm being charged through the second data line Dm2.
